(19) United States
(12) Patent Application Publication
(10) Pub. No.: US 2022/0242247 A1
(43) Pub. Date: Aug. 4, 2022

(54) VEHICLE AND METHOD FOR OPERATING A VEHICLE

(71) Applicant: Robert Bosch GmbH, Stuttgart (DE)

(72) Inventors: Christoph Woll, Gerlingen (DE); Dietrich Klauk, Stuttgart (DE)

(21) Appl. No.: 17/622,265

(22) PCT Filed: Jun. 9, 2020
(86) PCT No.: PCT/EP2020/065924

§ 371 Date: Dec. 23, 2021

(30) Foreign Application Priority Data
Jun. 26, 2019 (DE) 10 2019 209 280.2

(51) Int. Cl. B60L 3/00; B60L 58/18; H02J 7/00; B60L 58/12; B60L 50/51

(52) U.S. Cl. CPC B60L 3/0046; B60L 58/18; H02J 7/0019; B60L 2210/00; B60L 3/0092; B60L 50/51; B60L 2220/42; B60L 58/12

(57) ABSTRACT

A vehicle and a method for operating a vehicle including at least one switching unit and, as components, at least two electrical energy stores, at least two electric motors, and at least two converters. One electrical energy store is electrically conductively connectable with the aid of a switching unit alternately to one or multiple converters. One converter is electrically conductively connectable with the aid of a switching unit alternately to one or multiple electric motors. One converter is electrically conductively connectable with the aid of a switching unit alternately to one or multiple electrical energy stores.

### FIELD

The present invention relates to a vehicle and a method for operating a vehicle.

### BACKGROUND INFORMATION

German Patent Application No. DE 10 2016 011 238 A1 describes a switching arrangement for an electrical drivetrain, which includes four electric motors, four converters, and four batteries. One converter is permanently associated with each electric motor. Each battery is connectable with the aid of the switching arrangement to one or multiple electric motors.

Korea Patent Application No. KR 2017 0008922 A describes a converter system for a vehicle, which includes a first and a second motor. The converter system includes a first converter and a second converter. The first and second converters are each connectable to the first motor or the second motor.

German Patent Application No. DE 10 2015 011 230 A1 describes an energy store for an electrical AC voltage network including converters, storage elements, and multiplexer switching units.

U.S. Patent Application Publication No. US 2017/0244248 A1 describes an inverter system including multiplexer switching units.

### SUMMARY

In accordance with the present invention, in the vehicle including at least one switching unit and, as components, at least two electrical energy stores, at least two electric motors, and at least two converters, an electrical energy store is electrically conductively connectable with the aid of a switching unit alternately to one or multiple converters, a converter is electrically conductively connectable with the aid of a switching unit alternately to one or multiple electric motors, a converter is electrically conductively connectable with the aid of a switching unit alternately to one or multiple electrical energy stores.

According to the present invention, the components of the vehicle are not permanently associated with one another, the association of the components with one another is thus variable. A configuration of the components of the vehicle is thus selectable, using which the efficiency of the vehicle is optimizable.

In the event of a failure of one component of the vehicle, this component may advantageously be replaced by an equivalent component. For this purpose, the failed component is disconnected with the aid of the switching unit from the other components and the equivalent component is connected in place of the failed component to the other components.

Further advantageous specific embodiments of the present invention are disclosed herein.

According to one advantageous embodiment of the present invention, each electrical energy store is electrically conductively connectable to each converter. A defective electrical energy store or an electrical energy store which has a low charge level is replaceable by any other operational electrical energy store. The availability of the vehicle is thus improved.

In accordance with an example embodiment of the present invention, it is furthermore advantageous if each electric motor is electrically conductively connectable to each converter. A defective converter is thus replaceable by any other operational converter. The availability of the vehicle is thus further improved.

A first switching unit is advantageously situated between the electric motors and the converters. Each electric motor is connectable, in particular connectable in an automated manner, to each converter with the aid of the first switching unit.

It is advantageous if a second switching unit is situated between the electrical energy stores and the converters. Each electrical energy store is connectable, in particular connectable in an automated manner, to each converter with the aid of the second switching unit.

In accordance with an example embodiment of the present invention, the first switching unit and/or the second switching unit is advantageously designed as a current switch. The switching unit may thus be designed to be robust.

According to another advantageous embodiment of the present invention, at least one switching unit is designed as a multiplexer switching unit. The switching unit may thus be designed to be compact.

Furthermore, it is advantageous if the vehicle includes a control unit, which is configured to activate at least one switching unit. The operating states of the components of the vehicle may be detected and evaluated with the aid of the control unit. The switching unit is activatable in such a way that the efficiency of the vehicle is optimizable on the basis of the operating states of the components. The energy consumption or the wear of the vehicle is minimized or the service life of the components or the vehicle is maximized, for example.

In accordance with an example embodiment of the present invention, it is advantageous if the control unit is configured to evaluate the operating states of the components and to activate the at least one switching unit in such a way that the components are connected to one another in such a way that an efficiency of the vehicle is optimized. Therefore, for example, the energy consumption or the wear of the vehicle may be minimized or the service life of the components of the vehicle may be maximized.

The control unit is advantageously configured to recognize a critical operating state of at least one component and to activate the at least one switching unit in such a way that this component is disconnected from the other components and an equivalent component is connected in place of this component to at least one of the components. The availability of the vehicle is thus improved.

Furthermore, it is advantageous if the converter is designed as a single converter unit, in particular which includes a multicore power electronics unit. The converters may be designed to be compact due to the use of a single converter unit. The converter unit includes at least two autarkic subunits, which each function as a converter.

The components are advantageously situated centrally in the vehicle. The components may be situated centrally in a middle area of the vehicle floor, due to which they are protected from mechanical damage in the case of an accident of the vehicle.

Alternatively, the components are situated in a decentralized manner in the vehicle. The installation space of the vehicle is thus better usable than in the case of a central arrangement. The components are situated where space is available in the vehicle.

In accordance with a method for operating a vehicle in accordance with an example embodiment of the present invention, in a vehicle, including at least one switching unit and, as components, at least two electric motors, at least two converters, and at least two electrical energy stores, the operating states of the components are detected and evaluated and the components are selected and connected to one another with aid of the switching unit, an efficiency of the vehicle being used in the selection of the components.

In accordance with an example embodiment of the present invention, the components may be selected and combined with one another in such a way that the efficiency of the vehicle is optimized. The availability and/or the range of the vehicle is thus improved and/or the wear is reduced.

According to one advantageous embodiment of the present invention, when a critical operating state of one of the components is established, the component which has a critical operating state is replaced by an equivalent component with the aid of the switching unit. The component is thus exchangeable in a simple manner, in particular in an automated manner. This component remains in the vehicle and is solely disconnected from the other components by the switching unit. The component which has a critical operating state may be switched on again at a later point in time and/or may be removed from the vehicle while the vehicle is in a repair shop.

It is advantageous if the switching unit, to replace the component which has a critical operating state, disconnects this component from the other components, and then the switching unit connects the equivalent component in place of the component which has a critical operating state to at least one of the other components. The component may thus be exchanged in an automated manner. The availability of the vehicle is improved.

The method may be advantageously carried out while the vehicle is driven. No failure of the vehicle occurs. The vehicle may continue to drive with a component which has a critical operating state until it is replaced in a repair shop or the component is ready for operation again.

The above embodiments and refinements may be combined with one another as desired, if reasonable. Further possible embodiments, refinements, and implementations of the present invention also include combinations which were not explicitly mentioned of features of the present invention described above or hereinafter with respect to the exemplary embodiments. In particular, those skilled in the art will also add individual aspects as improvements or supplements to the particular basic form of the present invention, in view of the disclosure herein.

### BRIEF DESCRIPTION OF THE DRAWINGS

In the following section, the present invention is explained on the basis of exemplary embodiments, from which further features according to the present invention may result, but to which the scope of the present invention is not restricted. The exemplary embodiments are shown in the figures.

FIG. 1 shows a schematic representation of a drivetrain of a first exemplary embodiment of a vehicle 1 according to the present invention.

FIG. 2 shows a schematic representation of a drivetrain of a second exemplary embodiment of a vehicle 21 according the present invention.

FIG. 3 shows a schematic representation of a drivetrain of a third exemplary embodiment of a vehicle 31 according to the present invention.

FIG. 4 shows a flowchart of the method according to an example embodiment of the present invention for operating a vehicle 1, 21, 31.

### DETAILED DESCRIPTION OF EXAMPLE EMBODIMENTS

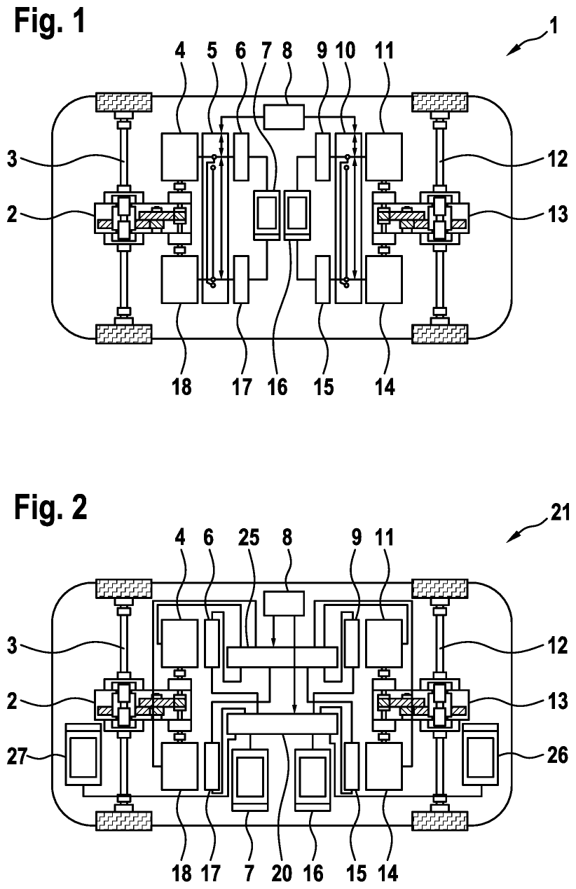

A first exemplary embodiment of vehicle 1 according to the present invention is shown in FIG. 1.

The drivetrain of the first exemplary embodiment of vehicle 1 includes:
a first drive axle 3,
a second drive axle 12,
a first transmission 2,
a second transmission 13,
a first electric motor 4,
a second electric motor 11,
a third electric motor 18,
a fourth electric motor 14,
a first electrical energy store 7,
a second electrical energy store 16,
a first converter 6,
a second converter 9,
a third converter 17,
a fourth converter 15,
a first switching unit 5,
a second switching unit 10, and
a control unit 8.

First drive axle 3 is connectable, in particular may be coupled, with the aid of first transmission 2 to first electric motor 4 and/or third electric motor 18. First drive axle 3 is drivable with the aid of first electric motor 4 and/or third electric motor 18.

Second drive axle 12 is connectable, in particular may be coupled, with the aid of second transmission 13 to second electric motor 11 and/or fourth electric motor 14. Second drive axle 12 is drivable with the aid of second electric motor 11 and/or with aid of fourth electric motor 4.

First transmission 2 and/or second transmission 13 is designed as a coupling transmission.

First electric motor 4 is connectable with the aid of first switching unit 5 to first converter 6 or third converter 17. First converter 6 is configured to generate an AC voltage for first electric motor 4 from a DC voltage of first electrical energy store 7. Third converter 17 is configured to generate an AC voltage for first electric motor 4 from a DC voltage of first electrical energy store 7.

Third electric motor 18 is connectable with the aid of first switching unit 5 to first converter 6 or third converter 17. First converter 6 is configured to generate an AC voltage for third electric motor 18 from a DC voltage of first electrical energy store 7. Third converter 17 is configured to generate an AC voltage for third electric motor 18 from a DC voltage of first electrical energy store 7.

Second electric motor 11 is connectable with the aid of second switching unit 10 to second converter 9 or fourth converter 15. Second converter 9 is configured to generate an AC voltage for second electric motor 11 from a DC voltage of second electrical energy store 16. Second converter 9 is configured to generate an AC voltage for second electric motor 11 from a DC voltage of second electrical energy store 16.

Fourth electric motor 14 is connectable with the aid of second switching unit 10 to second converter 9 or fourth converter 15. Second converter 9 is configured to generate an AC voltage for fourth electric motor 14 from a DC voltage of second electrical energy store 16. Second converter 9 is configured to generate an AC voltage for fourth electric motor 14 from a DC voltage of second electrical energy store 16.

First electrical energy store 7 is electrically conductively connected to first converter 6 and/or third converter 17. Second electrical energy store 16 is electrically conductively connected to second converter 9 and/or fourth converter 15.

Control unit 8 controls first switching unit 5 and second switching unit 10. First switching unit 5 and second switching unit 10 are each designed as a current switch and are connected in a signal-conducting manner to control unit 8.

Control unit 8 is preferably designed as a central control unit of vehicle 1. As the central control unit of vehicle 1, control unit 8 is connected in a signal-conducting manner to converters 6, 9, 15, 17, sensors, and an operating interface of the vehicle.

FIG. 2 shows a second exemplary embodiment of vehicle 21 according to the present invention.

The drivetrain of the second exemplary embodiment of vehicle 21 includes:
a first drive axle 3,
a second drive axle 12,
a first transmission 2,
a second transmission 13,
a first electric motor 4,
a second electric motor 11,
a third electric motor 18,
a fourth electric motor 14,
a first electrical energy store 7,
a second electrical energy store 16,
a third electrical energy store 27,
a fourth electrical energy store 26,
a first converter 6,
a second converter 9,
a third converter 17,
a fourth converter 15,
a first switching unit 25,
a second switching unit 20, and
a control unit 8.

The difference from the first exemplary embodiment of vehicle 1 in the second exemplary embodiment of vehicle 21 is that the drivetrain of vehicle 21 includes four electrical energy stores 7, 16, 26, 27.

Each of electrical energy stores 7, 16, 26, 27 is electrically conductively connectable with the aid of second switching unit 20 to each of converters 6, 9, 15, 17. One electrical energy store 7, 16, 26, 27 is electrically conductively connectable to all converters 6, 9, 15, 17, to one of converters 6, 9, 15, 17, or to a subset of converters 6, 9, 15, 17, in particular to two or three converters 6, 9, 15, 17. On the other hand, one converter 6, 9, 15, 17 is electrically conductively connectable to all electrical energy stores 7, 16, 26, 27, to one of electrical energy stores 7, 16, 26, 27, or to a subset of electrical energy stores 7, 16, 26, 27, in particular to two or three electrical energy stores 7, 16, 26, 27.

Each of converters 6, 9, 15, 17 is electrically conductively connectable with the aid of first switching unit 25 to each of electric motors 4, 11, 14, 18. One converter 6, 9, 15, 17 is electrically conductively connectable to all electric motors 4, 11, 14, 18, to one of electric motors 4, 11, 14, 18, or to a subset of electric motors 4, 11, 14, 18, in particular to two or three electric motors 4, 11, 14, 18.

First switching unit 25 and second switching unit 20 are designed as multiplexer switching units.

According to the second exemplary embodiment of vehicle 21, electrical energy stores 7, 16, 26, 27 and/or converters 6, 9, 15, 17 are situated in a decentralized manner in vehicle 21. One converter 6, 9, 15, 17 is situated adjacent to one electric motor 4, 11, 14, 18 in each case, in particular situated at electric motor 4, 11, 14, 18. Electrical energy stores 7, 16, 26, 27 are situated adjacent to electric motors 4, 11, 14, 18 between drive axles 3, 12 or in front of or behind both drive axles 3, 12 in the travel direction of the vehicle.

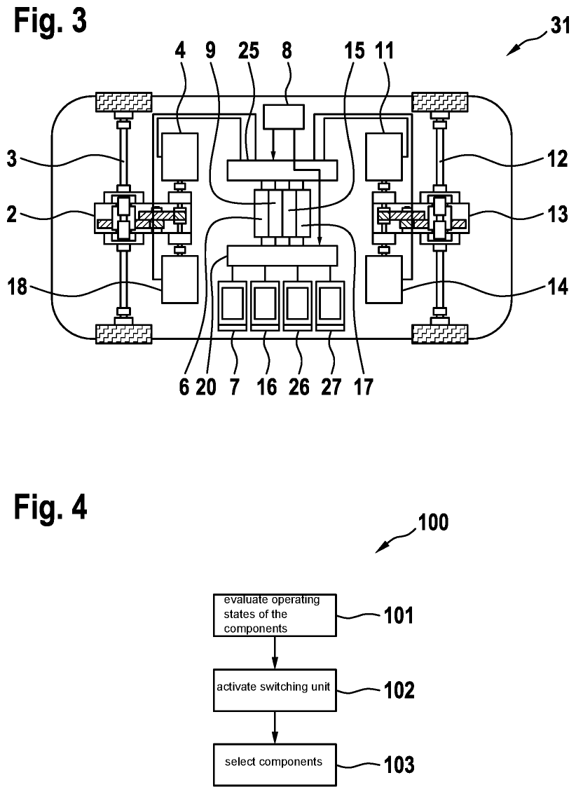

FIG. 3 shows a third exemplary embodiment of vehicle 31 according to the present invention.

The difference from the second exemplary embodiment of vehicle 21 in third exemplary embodiment of vehicle 31 is that converters 6, 9, 15, 17 and/or electrical energy stores 7, 16, 26, 27 are situated centrally in vehicle 31. Converters 6, 9, 15, 17 and/or electrical energy stores 7, 16, 26, 27 are situated between first drive axle 3 and second drive axle 12.

Converters 6, 9, 15, 17 are preferably designed as a central converter unit, in particular the converter unit including a multicore power electronics unit.

A flowchart of the method according to the present invention for operating a vehicle 1, 21, 31 is shown in FIG. 4. Vehicle 1, 21, 31 includes at least one switching unit 5, 10, 20, 25 and, as components, at least two electric motors 4, 11, 14, 18, at least two converters 6, 9, 15, 17, and at least two electrical energy stores 7, 16, 26, 27.

In a first method step 101, the operating states of the components are evaluated and a critical operating state of one of the components is possibly established.

In a second method step 102, switching unit 5, 10, 20, 25 is activated.

In a third method step 103, the components are selected on the basis of their operating states and connected to one another in such a way that an efficiency of the vehicle is optimized. The components are selected in such a way that they are adapted to the operating strategy of the vehicle. A different torque demand of the two drive axles 3, 12 may exist due to the loading of the vehicle, for example. Alternatively, the charging strategy may be adapted by the selection of the components to extend the range of the vehicle.

The component which has a critical operating state is preferably replaced by an equivalent component. Switching unit 5, 10, 20, 25 disconnects the component which has a critical operating state from the other components. The switching unit then connects the equivalent component, in place of the component which has a critical operating state, to at least one of the other components.

The method is preferably carried out while the vehicle is driven.

A critical operating state of an electric motor is, for example, a failure of the electric motor and/or a blockage of the rotor of the electric motor and/or overheating of the electric motor.

A critical operating state of an electrical energy store is, for example, a low charge level or an overvoltage or an excessively high or excessively low temperature of the electrical energy store.

A critical operating state of a converter is, for example, an overload or a defect or overheating of the converter.

One converter may be electrically conductively connected to one or multiple, in particular all, electric motors.

One electrical energy store may be connected to one or multiple, in particular all, converters.

An electrical energy store is understood here as a rechargeable energy store, in particular including an electrochemical energy store cell and/or an energy store module including at least one electrochemical energy store cell and/or an energy store pack including at least one energy store module. The energy store cell may be designed as a lithium-based battery cell, in particular a lithium-ion battery cell. Alternatively, the energy storage cell is designed as a lithium polymer battery cell or nickel metal hydride battery cell or lead acid battery cell or lithium air battery cell or lithium sulfur battery cell. Alternatively, the electrical energy store cell may be designed as a fuel cell or the electrical energy store may include at least one fuel cell.

A vehicle is understood here as a land vehicle, in particular a passenger vehicle or a bus or a truck or a driverless transport system, or a watercraft or an aircraft. The vehicle may be designed to be autonomously controllable.

1-15. (canceled)

16. A vehicle, comprising:
at least one switching unit; and
components including at least two electrical energy stores, at least two electric motors, and at least two converters;
wherein:
at least one of the electrical energy stores is electrically conductively connectable using a switching unit alternately to one or multiple of the converters,
at least one of the converters is electrically conductively connectable using the switching unit alternately to one or multiple of the electric motors, and
at least one of the converters is electrically conductively connectable using the switching unit alternately to one or multiple of the electrical energy stores.

17. The vehicle as recited in claim 16, wherein each of the electrical energy stores is electrically conductively connectable to each of the converters.

18. The vehicle as recited in claim 16, wherein each of the electric motors is electrically conductively connectable to each of the converters.

19. The vehicle as recited in claim 16, wherein a first switching unit of the at least one switching unit is situated between the electric motors and the converters.

20. The vehicle as recited in claim 19, wherein the at least one switching unit includes at least two switching units, and wherein a second switching unit of the switching units is situated between the electrical energy stores and the converters.

21. The vehicle as recited in claim 20, wherein the first switching unit and/or the second switching unit is a current switch.

22. The vehicle as recited in 20, wherein at least one of the switching units is a multiplexer switching unit.

23. The vehicle as recited in claim 16, wherein the vehicle includes a control unit, which is configured to activate the at least one switching unit.

24. The vehicle as recited in claim 23, wherein the control unit is configured to evaluate operating states of the components and to activate the at least one switching unit in such a way that the components are connected to one another in such a way that an efficiency of the vehicle is optimized, and/or the control unit is configured to recognize a critical operating state of at least one of the components and to activate the at least one switching unit in such a way that the at least one of the components having the critical operating state is disconnected from the other components and an equivalent component is connected, in place of the at least one of the components having the critical operating state, to at least one of the other components.

25. The vehicle as recited in claim 16, wherein the converters are designed as a single converter unit, the converter unit including a multicore power electronics unit.

26. The vehicle as recited in claim 16, wherein the components are situated centrally or in a decentralized manner in the vehicle.

27. A method for operating a vehicle including at least one switching unit, and components including at least two electric motors, at least two converters, and at least two electrical energy stores, the method comprising the following steps:
detecting and evaluating operating states of the components; and
selecting and connecting the components to one another using the switching unit, an efficiency of the vehicle being used in the selection of the components.

28. The method as recited in claim 27, wherein when a critical operating state of one of the components is established, the component which has the critical operating state is replaced using the switching unit by an equivalent component.

29. The method as recited in claim 27, wherein, to replace the component which has the critical operating state, the switching unit disconnects the component which has the critical operating state from the other components and then the switching unit connects the equivalent component, in place of the component which has a critical operating state, to at least one of the other components.

30. The method as recited in claim 27, wherein the method is carried out while the vehicle is driven.
